(19) United States
(12) Patent Application Publication
(10) Pub. No.: US 2008/0047991 A1
(43) Pub. Date: Feb. 28, 2008

(54) PORTABLE DISPLAY

(76) Inventor: David Everett, Boston, MA (US)

Correspondence Address: LOWRIE, LANDO & ANASTASI, LLP, ONE MAIN STREET, SUITE 1100, CAMBRIDGE, MA, 02142, US

(21) Appl. No.: 11/829,193

(22) Filed: Jul. 27, 2007

Related U.S. Application Data
(60) Provisional application No. 60/834,233, filed on Jul. 28, 2006.

(51) Int. Cl. A45F 3/10; B65D 85/86; H04N 5/66

(52) U.S. Cl. 224/265; 206/701; 348/739

(57) ABSTRACT

A portable display may include a screen support configured to receive a display screen, and a harness assembly coupled to the screen support. The harness assembly may include a pair of arms hingedly coupled to the screen support and configured to be worn by a wearer of the portable display. The arms may be movable between a use position in which the harness assembly may be worn on the shoulders of the wearer and a stowed position in which the arms are folded over one another.

### RELATED APPLICATION

This application claims priority under 35 U.S.C. § 119(e) to U.S. Provisional Application No. 60/834,233, entitled “PORTABLE DISPLAY,” filed Jul. 28, 2006, which is hereby incorporated by reference in its entirety for all purposes.

### BACKGROUND OF THE INVENTION

1. Field of the Invention

The present invention relates generally to displays, and more particularly to a portable display that can be worn by a person to create a “walking advertisement.”

2. Discussion of Related Art

Portable displays are known in the art. Reference may be made to U.S. Pat. Nos. 5,416,310 and 5,912,653 for examples of prior portable displays. Disadvantages associated with such displays is that they are bulky in appearance, uncomfortable to wear and are not particularly suited for advertisement purposes.

### SUMMARY OF THE INVENTION

One aspect of the invention may be directed to a portable display comprising a screen support configured to receive a display screen, and a harness assembly coupled to the screen support. In a certain embodiment, the harness assembly may comprise a pair of arms hingedly coupled to the screen support and configured to be worn by a wearer of the portable display. The arms may be movable between a use position in which the harness assembly may be worn on the shoulders of the wearer and a stowed position in which the arms are folded over one another.

Embodiments of the invention may include the provision of arms constructed and arranged so that a first arm may be folded over to its stowed position and a second arm may be folded over the first arm. Each arm may have a hinge to connect the arm to the base plate, the hinge being configured with two arm parts that are pinned to respective frame members connected to the base plate. In one embodiment, the arm parts and frame members of one arm may be longer in length than the arm parts and frame members of the other arm. In another embodiment, a display screen may be coupled to the screen support. The screen support may comprise a base plate constructed and arranged to secure the display screen to the harness assembly.

Another aspect of the invention may be directed to a portable display comprising a display screen, means for mounting the display screen, and a harness assembly coupled to the means for mounting the display screen. In a certain embodiment, the harness assembly may comprise a pair of arms of inverted U-shaped construction that are configured to be worn by a wearer of the portable display.

### DESCRIPTION OF THE DRAWINGS

For a better understanding of the present invention, reference is made to the drawing figures which are incorporated herein by reference and in which:

FIG. 1 is a perspective view of a portable display of an embodiment of the invention;

FIG. 2 is another perspective view of the portable display shown in FIG. 1;

FIG. 3 is a rear view of a harness assembly of the portable display shown in FIGS. 1 and 2;

FIG. 4 is a rear perspective view of the harness assembly;

FIG. 5 is a front perspective view of the harness assembly;

FIG. 6 is a rear perspective view of the harness assembly, showing an arm of the harness assembly in a partially collapsed position;

FIG. 7 is a front perspective view of a portable display of an embodiment of the invention being worn by a person; and

FIG. 8 is a rear perspective view of the portable display shown in FIG. 7.

### DETAILED DESCRIPTION OF THE INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

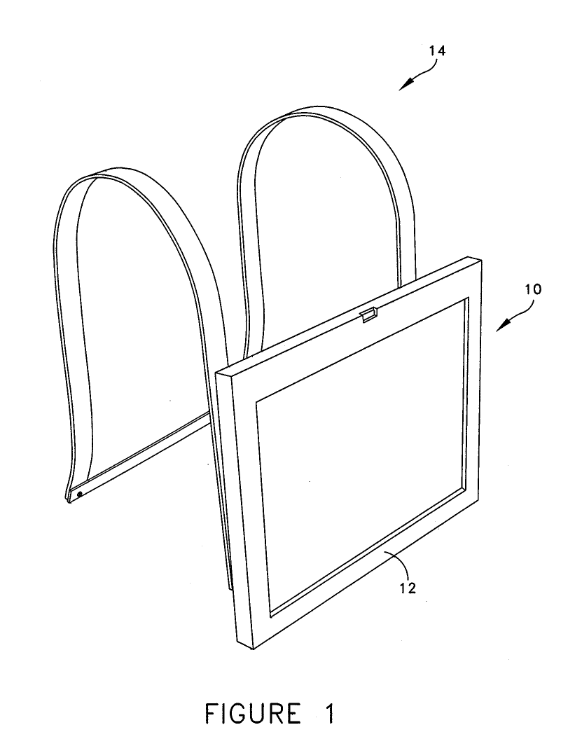

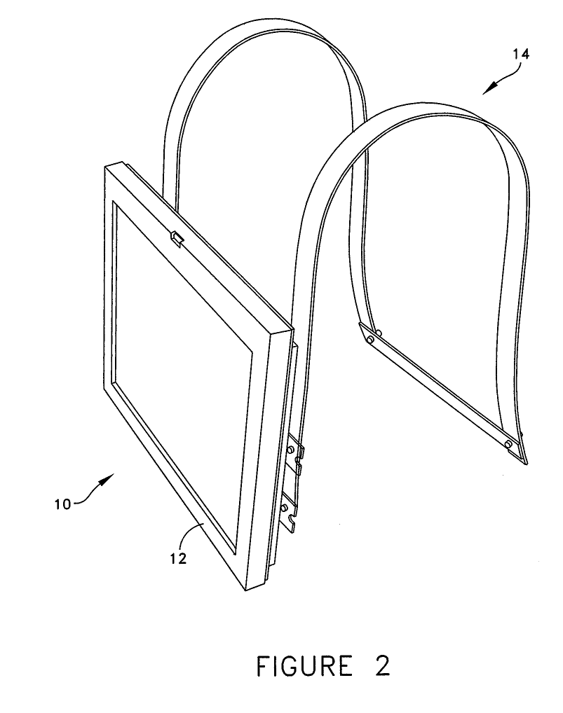

A portable display of an embodiment of the invention is shown and generally indicated at 10 in FIGS. 1 and 2. As shown, the portable display includes a display screen 12 and a harness assembly, which is generally indicated at 14. The display screen 12 may be an off-the-shelf flat panel display, such as those commercially available at electronics stores, capable of displaying moving images. In other embodiments, the display screen 12 may be constructed particularly for application on the harness assembly 14. The display screen 12 may include a flat panel screen area surrounded by a frame or housing. Provided on the back of the housing may be suitable connections (not shown) for attaching the display screen 12 to the harness assembly 14 in the same manner that the display screen would be attached to a wall outlet, for example. Suitable controls may be provided for controlling the operation of the display screen.

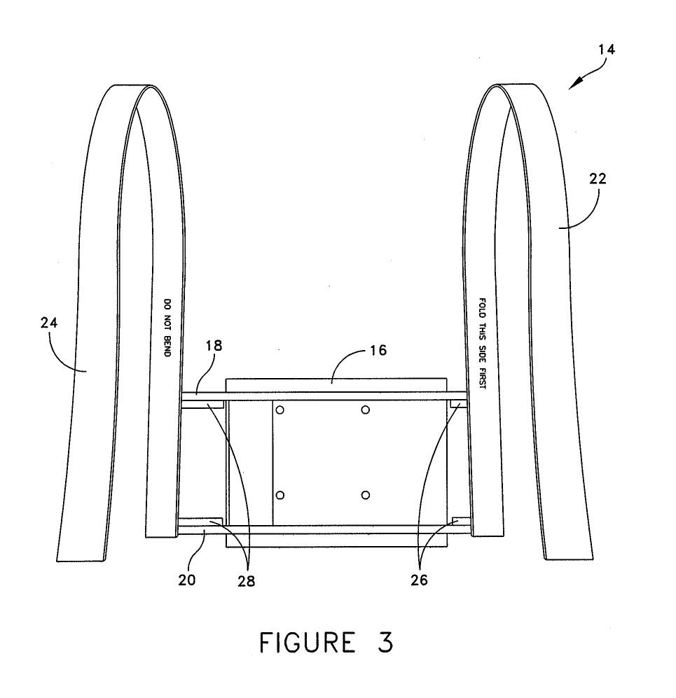

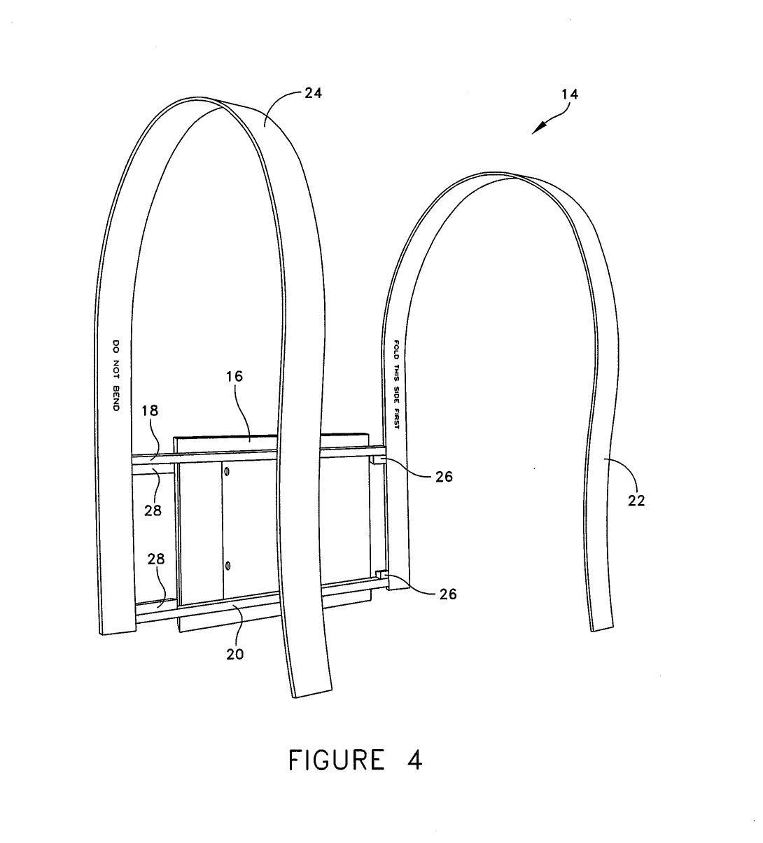

The harness assembly 14 of the portable display 10 is illustrated in FIGS. 3-6. As shown, the harness assembly 14 may be configured to include a screen support embodying a base plate 16, a pair of support frame members 18, 20 attached to the base plate, and a pair of arms 22, 24 hingedly connected to the support frame members. In a certain embodiment, the harness assembly 14 may be fabricated from lightweight, rigid material, such as aluminum or an aluminum alloy. Stainless steel and/or a rigid plastic may also be employed to fabricate the various components of the portable display 10. For example, the arms 22, 24 of the harness assembly 14 may be fabricated from lightweight, rigid plastic and the base plate 16 and the frame members 18, 20 may be fabricated from metal, such as aluminum, an aluminum alloy or even stainless steel. The base plate 16 may include several openings configured to mount the display screen 12 on to the base plate of the harness assembly 14. The base plate 16 may be further configured to mount other items, such as a battery pack and controls for the display screen 12. In one embodiment, support frame members 18, 20 may be spot welded to the base plate 16 to provide a reliable, secure attachment of the screen display 12 to the other components of the harness assembly 14.

Each arm 22, 24 is generally of inverted U-shaped construction, designed to fit over the shoulders of the person wearing the portable display 10. Each arm 22, 24 is relatively thin, but sufficiently rigid so that the weight of the screen display 12, any ancillary components and the base plate 16 are transferred to arms 22, 24 and thus to the shoulders of the person wearing the portable display 10. The arms 22, 24 are configured so as to move between a use position in which the harness assembly may be worn over the shoulders of a person and a stowed position in which the arms are folded over one another so as to achieve a narrow side profile. Specifically, the arms 22, 24 are configured so that a first arm may be folded over to its stowed position (e.g., the right-hand arm 22 shown in FIG. 3) and a second arm (e.g., the left-hand arm 24 shown in FIG. 3) may be folded over the first arm. Once folded over to the stowed position, the arms may be used as a handle to carry the portable display by hand.

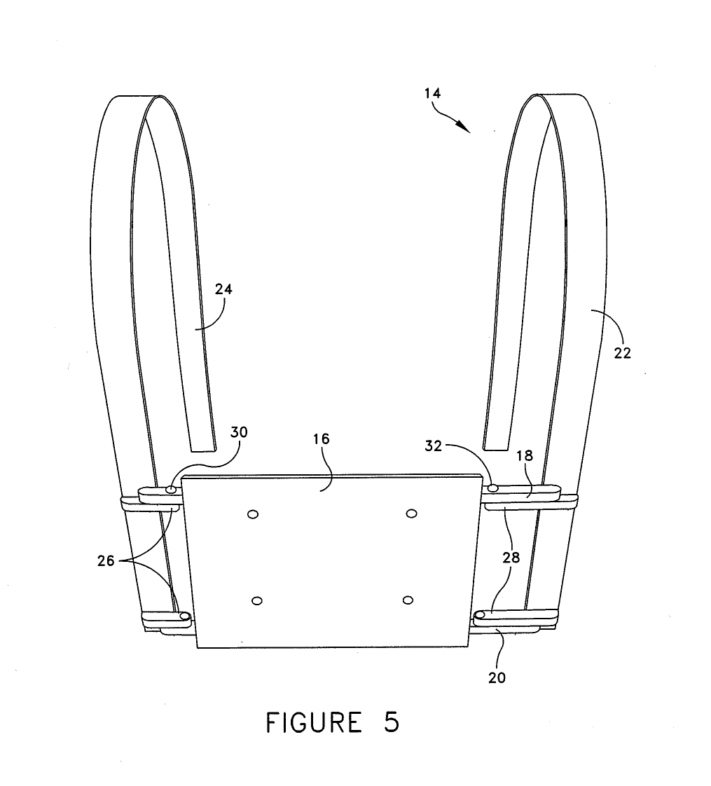

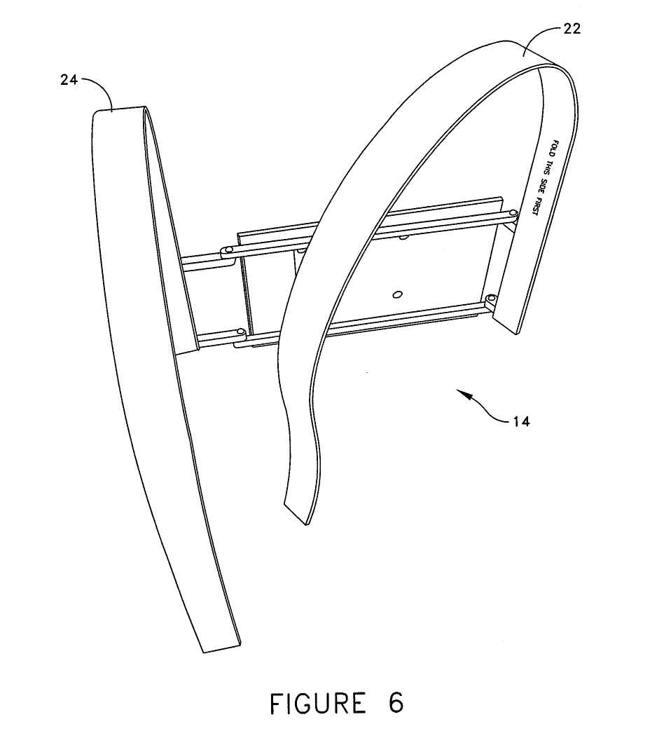

To achieve the movement of the arms between the use and stowed positions, each arm 22, 24 has a unique hinge to connect the arm to the support frame members 18, 20. Specifically, arm 22 has arm parts 26, which are adapted to be pivotably secured to the frame members 18, 20 by pins 30. Similarly, arm 24 has arm parts 28, which are adapted to be pivotably secured to the frame members 18, 20 by pins 32. In one embodiment, the arm parts 26, 28 are welded to their respective arm members 22, 24 and the pins 30, 32 are fabricated from a material resistant to wear, such as brass. For the left-hand arm 22 shown in FIG. 5 (i.e., the right-hand arm 22 shown in FIG. 3), the arm parts 26 and the frame members 18, 20 are relatively shorter in length than the arm parts 28 and frame members 18, 20 of the right-hand arm hinge arrangement. Thus, as shown in FIG. 6, when folding over the arm 22 to a collapse or stowed position, the hinge of the arm 24 extends out beyond the width of the arm 22 so as to prevent binding of the arm 24 when subsequently folding it over to its collapsed position.

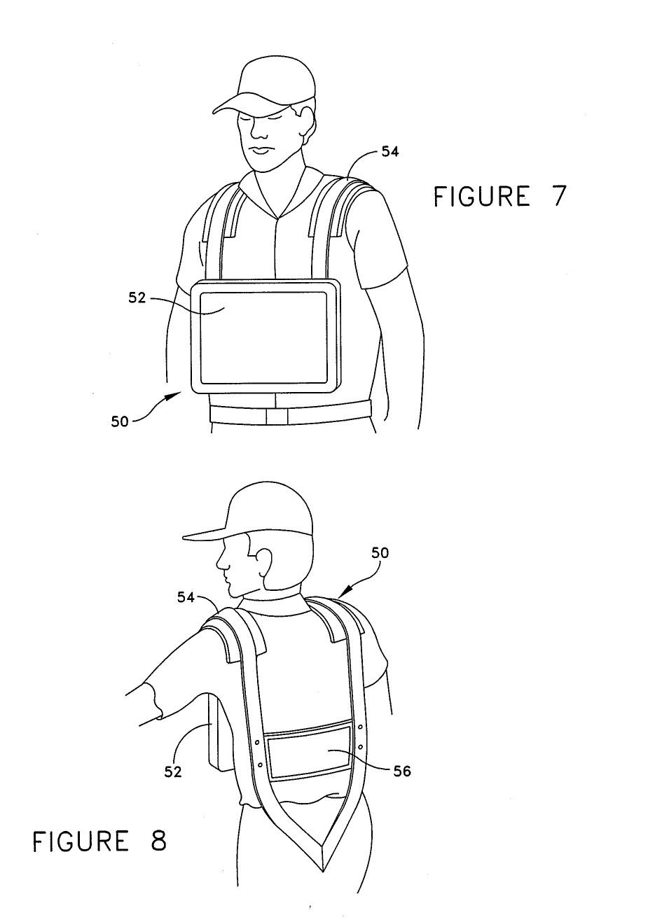

Referring to FIGS. 7 and 8, a portable display, generally indicated at 50, which is similar to the portable display 10 shown in FIGS. 1 and 2, is illustrated. The portable display 50 includes a screen display 52 and a harness assembly 54. As shown in FIG. 8, the harness assembly 54 may be configured to include a back plate 56, which may be arranged to mount the auxiliary components, such as a battery pack and a control for the screen display 52. In addition, the components of the harness assembly 54 of the portable display 50, i.e., the arm, frame members and base plate, may be unitary in construction and incapable of folding to the stowed position.

In certain embodiments, the portable display (10 or 50) may be worn as shown in FIGS. 7 and 8 with the display screen (12 or 52) positioned at the front of the wearer. However, it should be understood that the portable display may be configured so that the display screen is positioned at the back of the person wearing the portable display. Also, the portable display may be configured to have two display screens—one on the front and one on the back of the wearer, for example. In addition, as shown in FIGS. 1 and 2, the portable display (10 or 50) may be positioned so that it rests in an upright position when placed on a horizontal surface. In this upright position, the portable display may function as a desktop or table visual device.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A portable display comprising:
a screen support configured to receive a display screen; and
a harness assembly coupled to the screen support, the harness assembly comprising a pair of arms hingedly coupled to the screen support and configured to be worn by a wearer of the portable display, the arms being movable between a use position in which the harness assembly may be worn on the shoulders of the wearer and a stowed position in which the arms are folded over one another.

2. The portable display of claim 1, wherein the arms are constructed and arranged so that a first arm may be folded over to its stowed position and a second arm may be folded over the first arm.

3. The portable display of claim 2, wherein each arm has a hinge to connect the arm to the base plate.

4. The portable display of claim 3, wherein the hinge of each arm is configured with two arm parts that are pinned to respective frame members connected to the base plate.

5. The portable display of claim 4, wherein the arm parts and frame members of one arm are longer in length than the arm parts and frame members of the other arm.

6. The portable display of claim 1, further comprising a display screen coupled to the screen support.

7. The portable display of claim 6, wherein the screen support comprises a base plate constructed and arranged to secure the display screen to the harness assembly.

8. A portable display comprising:
a display screen;
means for mounting the display screen; and
a harness assembly coupled to the means for mounting the display screen, the harness assembly comprising a pair of arms of inverted U-shaped construction that are configured to be worn by a wearer of the portable display.

9. The portable display of claim 8, wherein the arms are movable between a use position in which the harness assembly may be worn on the shoulders of the wearer and a stowed position in which the arms are folded over one another.

10. The portable display of claim 9, wherein the arms are constructed and arranged so that a first arm may be folded over to its stowed position and a second arm may be folded over the first arm.

11. The portable display of claim 10, wherein each arm has a hinge to connect the arm to the base plate.

12. The portable display of claim 11, wherein the hinge of each arm is configured with two arm parts that are pinned to respective frame members connected to the base plate.

13. The portable display of claim 12, wherein the arm parts and frame members of one arm are longer in length than the arm parts and frame members of the other arm.

14. The portable display of claim 8, wherein the harness assembly is configured so that the display screen may be worn on the front and the back of a wearer.
